(19) United States
(12) Patent Application Publication
(10) Pub. No.: US 2024/0185069 A1
(43) Pub. Date: Jun. 6, 2024

(54) METHOD AND APPARATUS FOR TRAINING MODEL BASED ON RELATION NETWORK, AND METHOD AND APPARATUS FOR DETERMINING REPRESENTATION BASED ON RELATION NETWORK

(71) Applicant: Alipay (Hangzhou) Information Technology Co., Ltd., Hangzhou (CN)

(72) Inventors: Ke TU, Hangzhou (CN); Zhengwei WU, Hangzhou (CN); Binbin HU, Hangzhou (CN); Zhiqiang ZHANG, Hangzhou (CN)

(21) Appl. No.: 18/524,692

(22) Filed: Nov. 30, 2023

(30) Foreign Application Priority Data
Dec. 2, 2022 (CN) 202211538942.6

(51) Int. Cl. G06N 3/08; G06N 3/042

(52) U.S. Cl. CPC G06N 3/08; G06N 3/042

(57) ABSTRACT

A neighboring user node of a user node is selected by using an attention model, to determine a selective adjacency matrix of a relation network based on the selected neighboring user node. Then, a neighboring node representation is propagated to a corresponding user node based on a selective adjacency matrix by using a graph neural network, to obtain a user aggregation representation. A tapping behavior between a user and an object is fitted based on a similarity between the user aggregation representation and an object representation, to construct a prediction loss based on a difference between the tapping behavior and an existing tapping behavior, and update the attention model. The trained attention model can select a more reliable neighboring user.

### TECHNICAL FIELD

One or more embodiments of this specification relate to the field of computer technologies, and in particular, to a method and an apparatus for training a model based on a relation network, and a method and an apparatus for determining a representation based on a relation network.

### BACKGROUND

A graph learning model has achieved a remarkable success in fields such as biological medicine, commodity pushing, and social relationship mining. Data (including privacy data) in these fields is associated by using a structure of a relation network. Currently, people are increasingly concerned about the privacy data, and expect to extract useful information in the relation network without disclosing the privacy data. A plurality of applications can be implemented by using the relation network, and a social relationship in the relation network can add more rich information to represent a user with less behaviors. However, the social relationship is not completely reliable, and has very large noise.

Therefore, it is expected to extract a more reliable social relationship from a social relation network, thereby performing information propagation and aggregation based on the reliable social relationship.

### SUMMARY

One or more embodiments of this specification describe a method and an apparatus for training a model based on a relation network, and a method and an apparatus for determining a representation based on a relation network, to extract a more reliable social relationship from a social relation network, thereby performing information propagation and aggregation based on the reliable social relationship.

According to a first aspect, an embodiment provides a method for training an attention model based on a neighboring user in a relation network. A first relation network includes a plurality of user nodes, a plurality of object nodes, and an edge that represents an association relationship between different nodes, and the method includes:
selecting a neighboring user node of the user node based on a user node representation in the first relation network by using the attention model, to obtain selective attention of the user node to the neighboring user node of the user node; and determining a selective adjacency matrix including information in the selective attention among the plurality of user nodes;
propagating a neighboring node representation in the first relation network to a corresponding user node based on the selective adjacency matrix by using a graph neural network, to obtain a first user aggregation representation of the user node;
determining a first predicted association relationship between the user node and the object node based on the first user aggregation representation and an object representation in the first relation network;
determining a first prediction loss based on a difference between the first predicted association relationship and a first existing association relationship, where the first existing association relationship is an existing association relationship between the user node and the object node in the first relation network; and
updating at least the attention model based on the first prediction loss.

In an implementation, the attention model includes a neural network and a selection unit; and
the step of selecting a neighboring user node of the user node and the step of determining a selective adjacency matrix including information in the selective attention among the plurality of user nodes include:
determining initial attention of the user node to the neighboring user node of the user node based on the user node representation in the first relation network by using the neural network; and
selecting the neighboring user node based on the initial attention by using the selection unit, to obtain the selective attention of the user node to the neighboring user node of the user node; and determining the selective adjacency matrix including the information in the selective attention among the plurality of user nodes.

In an implementation, the step of selecting the neighboring user node based on the initial attention includes:
sampling the neighboring user node based on the initial attention according to a derivable sampling function.

In an implementation, the step of determining the selective adjacency matrix including the information in the selective attention among the plurality of user nodes includes:
determining a first original adjacency matrix among the plurality of user nodes; and
determining the selective adjacency matrix based on a product of a selective attention matrix and the first original adjacency matrix, where the selective attention matrix includes selective attention of the plurality of user nodes to neighboring user nodes of the user nodes.

In an implementation, the step of propagating a neighboring node representation in the first relation network to a corresponding user node includes:
propagating a neighboring user node representation and a neighboring object node representation in the first relation network to the corresponding user node based on the selective adjacency matrix and an adjacency matrix between the user node and the object node.

In an implementation, the step of determining a first predicted association relationship between the user node and the object node includes:
propagating the neighboring node representation to a corresponding object node based on an adjacency matrix between the object node in the first relation network and a neighboring node of the object node, to obtain a first object aggregation representation of the object node; and
determining a first predicted association relationship between the user node and the object node based on the first user aggregation representation and the first object aggregation representation.

In an implementation, the step of updating at least the attention model based on the first prediction loss includes:
updating the attention model and the graph neural network based on the first prediction loss.

According to a second aspect, an embodiment provides a method for determining a node representation in a relation network. A second relation network includes a plurality of user nodes, a plurality of object nodes, and an edge that represents an association relationship between different nodes, and the method includes:
determining a selective adjacency matrix among the plurality of user nodes by using a trained attention model, where the attention model is trained in the method according to the first aspect; and
propagating a neighboring node representation in the second relation network to a corresponding user node based on the selective adjacency matrix, to obtain a second user aggregation representation of the user node.

In an implementation, the step of propagating a neighboring node representation in the second relation network to a corresponding user node includes:
propagating a neighboring user node representation and a neighboring object node representation in the second relation network to the corresponding user node based on the selective adjacency matrix and an adjacency matrix between the user node and the object node.

According to a third aspect, an embodiment provides a method for training a representation aggregation model used to aggregate node representations in a relation network. A third relation network includes a plurality of user nodes, a plurality of object nodes, and an edge that represents an association relationship between different nodes, and the method includes:
determining a selective adjacency matrix among the plurality of user nodes by using a trained attention model, where the attention model is trained in the method according to the first aspect;
aggregating neighboring node representations in the third relation network to a corresponding user node based on the selective adjacency matrix along several types of propagation paths that are centered on the user node, to separately obtain several types of third user aggregation representations of the user node;
fusing several types of third user aggregation representations of any user node by using a first representation aggregation model, to obtain a user fusion representation;
determining a second predicted association relationship between the user node and the object node based on the user fusion representation and an object representation in the third relation network;
determining a second prediction loss based on a difference between the second predicted association relationship and a second existing association relationship, where the second existing association relationship is an existing association relationship between the user node and the object node in the third relation network; and
updating the first representation aggregation model based on the second prediction loss.

In an implementation, the step of determining a second predicted association relationship between the user node and the object node includes:
aggregating the neighboring node representations in the third relation network to a corresponding object node based on an adjacency matrix between the user node and the object node along several types of propagation paths that are centered on the object node, to separately obtain several types of third object aggregation representations of the object node;
fusing several types of third object aggregation representations of any object node by using a second representation aggregation model, to obtain an object fusion representation; and
determining a second predicted association relationship between the user node and the object node based on the user fusion representation and the object fusion representation.

In an implementation, the step of updating the first representation aggregation model based on the second prediction loss includes:
updating the first representation aggregation model and the second representation aggregation model based on the second prediction loss.

In an implementation, the step of determining a second prediction loss includes:
determining, from a neighboring user node of the user node, a neighboring user node selected by using the attention model;
determining a first similarity between the user node and the selected neighboring user node, and determining a second similarity between the user node and a user node other than the selected neighboring user node;
determining a first sub-loss based on the first similarity and the second similarity;
determining a second sub-loss based on the difference between the second predicted association relationship and the second existing association relationship; and
determining the second prediction loss based on the first sub-loss and the second sub-loss.

In an implementation, an association relationship between the user node and the object node in the third relation network is updated relative to an association relationship between a user node and an object node in a first relation network.

According to a fourth aspect, an embodiment provides an apparatus for training an attention model based on a neighboring user in a relation network. A first relation network includes a plurality of user nodes, a plurality of object nodes, and an edge that represents an association relationship between different nodes, and the apparatus includes:
a first attention module, configured to: select a neighboring user node of the user node based on a user node representation in the first relation network by using the attention model, to obtain selective attention of the user node to the neighboring user node of the user node; and determine a selective adjacency matrix including information in the selective attention among the plurality of user nodes;
a first propagation module, configured to propagate a neighboring node representation in the first relation network to a corresponding user node based on the selective adjacency matrix by using a graph neural network, to obtain a first user aggregation representation of the user node;
a first association module, configured to determine a first predicted association relationship between the user node and the object node based on the first user aggregation representation and an object representation in the first relation network;
a first loss module, configured to determine a first prediction loss based on a difference between the first predicted association relationship and a first existing association relationship, where the first existing association relationship is an existing association relationship between the user node and the object node in the first relation network; and
a first updating module, configured to update at least the attention model based on the first prediction loss.

According to a fifth aspect, an embodiment provides an apparatus for determining a node representation in a relation network. A second relation network includes a plurality of user nodes, a plurality of object nodes, and an edge that represents an association relationship between different nodes, and the apparatus includes:
a first determining module, configured to determine a selective adjacency matrix among the plurality of user nodes by using a trained attention model, where the attention model is trained in the method according to the first aspect; and
a second propagation module, configured to propagate a neighboring node representation in the second relation network to a corresponding user node based on the selective adjacency matrix, to obtain a second user aggregation representation of the user node.

According to a sixth aspect, an embodiment provides an apparatus for training a representation aggregation model used to aggregate node representations in a relation network. A third relation network includes a plurality of user nodes, a plurality of object nodes, and an edge that represents an association relationship between different nodes, and the apparatus includes:
a second determining module, configured to determine a selective adjacency matrix among the plurality of user nodes by using a trained attention model, where the attention model is trained in the method according to the first aspect;
a third propagation module, configured to propagate a neighboring node representation in the third relation network to a corresponding user node based on the selective adjacency matrix along several types of propagation paths that are centered on the user node, to separately obtain several types of third user aggregation representations of the user node;
a first fusion module, configured to fuse several types of third user aggregation representations of any user node by using a first representation aggregation model, to obtain a user fusion representation;
a second association module, configured to determine a second predicted association relationship between the user node and the object node based on the user fusion representation and an object representation in the third relation network;
a second loss module, configured to determine a second prediction loss based on a difference between the second predicted association relationship and a second existing association relationship, where the second existing association relationship is an existing association relationship between the user node and the object node in the third relation network; and
a second updating module, configured to update the first representation aggregation model based on the second prediction loss.

According to a seventh aspect, an embodiment provides a computer-readable storage medium. The computer-readable storage medium stores a computer program, and when the computer program is executed on a computer, the computer is enabled to perform the method according to any one of the first aspect to the third aspect.

According to an eighth aspect, an embodiment provides a computing device, including a memory and a processor. The memory stores executable code, and when the processor executes the executable code, the method according to any one of the first aspect to the third aspect is implemented.

According to the method and the apparatus provided in the embodiments of this specification, a neighboring user node is selected by using an attention model, and a selective adjacency matrix is obtained based on the selected neighboring user node; a neighboring node representation in a relation network is propagated to a user node based on the selective adjacency matrix by using a graph neural network, to obtain a user aggregation representation; and an association behavior of a user for an object is fitted based on the user aggregation representation, to construct a prediction loss. Higher reliability of a neighboring user selected by the attention model leads to a more accurate association behavior that is of the user for the object and that is fitted based on the user aggregation representation, and a smaller prediction loss. Therefore, in the embodiments of the specification, such a continuous training process can enable the attention model to select a neighboring user node with higher reliability, to extract a more reliable social relationship from a social relation network, thereby performing information propagation and aggregation based on the reliable social relationship.

### BRIEF DESCRIPTION OF DRAWINGS

To describe the technical solutions of the embodiments of the present invention more clearly, the following briefly describes the accompanying drawings needed for describing the embodiments. Apparently, the accompanying drawings in the following description show merely some embodiments of the present invention, and a person of ordinary skill in the art can still derive other drawings from these accompanying drawings without creative efforts.

FIG. 1 is a schematic diagram illustrating an implementation scenario of an embodiment disclosed in this specification;

FIG. 2 is a schematic flowchart illustrating a method for training an attention model, according to an embodiment;

FIG. 3 is a schematic flowchart illustrating a method for determining a node representation in a relation network, according to an embodiment;

FIG. 4 is a schematic flowchart illustrating a method for training a representation aggregation model, according to an embodiment;

FIG. 5 is a schematic block diagram illustrating an apparatus for training an attention model, according to an embodiment;

FIG. 6 is a schematic block diagram illustrating an apparatus for determining a node representation in a relation network, according to an embodiment; and

FIG. 7 is a schematic block diagram illustrating an apparatus for training a representation aggregation model, according to an embodiment.

### DESCRIPTION OF EMBODIMENTS

The following describes the solutions provided in this specification with reference to the accompanying drawings.

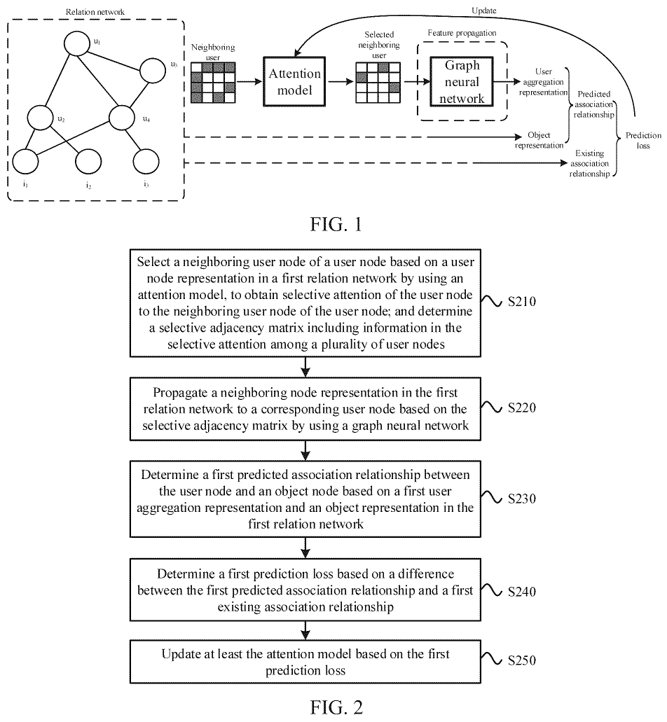

FIG. 1 is a schematic diagram illustrating an implementation scenario of an embodiment disclosed in this specification. A relation network includes a plurality of user nodes, a plurality of commodity nodes, and an edge that represents an association relationship between different nodes. For example, user nodes are u₁, u₂, u₃, u₄, etc., and commodity nodes are i₁, i₂, i₃, etc. There is a social relationship association between user nodes, and the user node and the commodity node are associated by using behaviors such as tapping or purchase. A neighboring user node in the relation network is input into an attention model, the neighboring user node is selected by using the attention model, and feature propagation of the user node is implemented based on the selected neighboring user node by using a graph neural network, to obtain a user aggregation representation. Then, a predicted association relationship between the user node and an object node is determined based on the user aggregation representation and an object representation of the object node, and a prediction loss is constructed by using an existing association relationship in the relation network, to update the attention model to reduce the prediction loss. When the attention model is trained, the attention model can select a more reliable neighboring user node.

The relation network includes a plurality of nodes and a plurality of edges. The user node in the relation network represents a user, and the commodity node represents a commodity. The commodity node is an object node that represents an object, and the object includes a complex of an item and a service for use, including a product and a commodity. The edge in the relation network includes an edge that represents an association relationship among a plurality of user nodes, and an edge that represents an association relationship between a user node and an object node. An association relationship between user nodes can include a family relationship, a like relationship, a transfer relationship, a loan relationship, etc. An association relationship between the user node and the object node can include tapping, purchase, allocation, subordination, etc.

A social relationship between user nodes is relatively stable, and a relationship between the user node and the object node may change rapidly with time. In a real-time online service, the association relationship between the user node and the object node can change in real time.

Data in the relation network can be generated based on service data of a service platform, and includes privacy data. To provide a better service, the service platform wants to dig deeper information from the relation network. For example, neighboring node representations around a user node are aggregated by using the relation network, so that more diversified user node representations exist and a user expression capability is enhanced. However, a social relationship between users is strong or weak, and has a different reliability degree. Therefore, there is large noise.

To extract a more reliable social relationship from a social relation network and reduce impact of noise, an embodiment of this specification provides a method for training an attention model based on a neighboring user in a relation network. The method includes the following steps: Step S210: Select a neighboring user node of a user node based on a user node representation in a first relation network by using the attention model, to obtain selective attention of the user node to the neighboring user node of the user node; and determine a selective adjacency matrix including information in the selective attention among a plurality of user nodes. Step S220: Propagate a neighboring node representation in the first relation network to a corresponding user node based on the selective adjacency matrix by using a graph neural network, to obtain a first user aggregation representation of the user node. Step S230: Determine a first predicted association relationship between the user node and an object node based on the first user aggregation representation and an object representation in the first relation network. Step S240: Determine a first prediction loss based on a difference between the first predicted association relationship and a first existing association relationship. Step S250: Update at least the attention model based on the first prediction loss. In the above-mentioned training process, a neighboring user node selected by the attention model is continuously adjusted based on an existing association relationship between the user node and the object node, so that the selected neighboring user node is increasingly reliable, and the obtained selective adjacency matrix has higher reliability and less noise. The following describes this embodiment in detail with reference to the flowchart shown in FIG. 2.

FIG. 2 is a schematic flowchart illustrating a method for training an attention model, according to an embodiment. A first relation network G₁ includes a plurality of user nodes that represent users, a plurality of object nodes that represent objects, and an edge that represents an association relationship between different nodes, including an edge between user nodes and an edge between a user node and an object node. The first relation network G₁ can be any relation network, for example, a relation network constructed based on service data of a service platform. The method can be performed by a computing device, and the computing device can be implemented by using any apparatus, device, platform, device cluster, etc. that has a computing and processing capability. The method includes the following steps.

In step S210, a neighboring user node of a user node is selected based on a user node representation in the first relation network G₁ by using an attention model N1, to obtain selective attention of the user node to the neighboring user node of the user node, and a selective adjacency matrix Aₛ′ including information in the selective attention among the plurality of user nodes is determined.

The attention model N1 is configured to determine a selective adjacency matrix including selective attention among a plurality of user nodes in a relation network. An input to the attention model N1 is an association relationship between a user node feature in the relation network and the user node, and an output is the selective adjacency matrix. The attention model N1 can be implemented by using a neural network. The user node can have a plurality of neighboring user nodes. Attention of the user node to the neighboring user node of the user node can be understood as a weight or a degree of importance of the neighboring user node to the user node. For example, in FIG. 1, neighboring user nodes of a user node u₁ includes u₂, u₃, and u₄. Attention of u₁ to u₂, attention of u₁ to u₃, and attention of up to u₁ to u₄ can respectively correspond to attention values. Attention can be between a user node and a neighboring user node of the user node, or can be expressed as attention of an edge between the user node and the neighboring user node. In other words, attention between u₁and u₂, attention between u₁ and u₃, and attention between u₁ and u₄ can respectively correspond to attention values. The attention model can select, from the neighboring user nodes of the user node as more important and reliable neighboring user node of the user node, neighbors whose quantity is a first quantity a₁, and assign different attention values to the selected neighboring user nodes, to obtain the selective attention of the user node to the neighboring user node of the user node. In an implementation, the attention model N1 can further reduce attention between the user node and a non-selected neighboring user node.

The attention model N1 can determine, for any user node u, selective attention of the user node u to a neighboring user node of the user node u, and perform such an operation for all user nodes in the relation network.

In an implementation, the attention model N1 includes a neural network and a selection unit. The neural network is configured to determine initial attention of the user node to the neighboring user node of the user node based on a user node representation in the relation network. The selection unit is configured to: select the neighboring user node based on the initial attention, to obtain the selective attention of the user node to the neighboring user node of the user node; and determine the selective adjacency matrix including the information in the selective attention among the plurality of user nodes.

Step S210 can include the following steps: The computing device determines the initial attention of the user node to the neighboring user node of the user node based on the user node representation in the first relation network G₁ by using the neural network; selects the neighboring user node based on the initial attention by using the selection unit, to obtain the selective attention of the user node to the neighboring user node of the user node; and determines the selective adjacency matrix including the information in the selective attention among the plurality of user nodes.

An input to the neural network is an association relationship between the user node representation in the first relation network G₁ and the user node, and an output is the initial attention. An input to the selection unit is the initial attention, and an output is the selective adjacency matrix. The neural network includes a to-be-trained parameter. The neural network can determine the initial attention based on the to-be-trained parameter and a similarity between the user node representation and a neighboring user node representation of the user node representation.

For example, in the neural network, for a user u, initial attention αᵤᵥ of a neighboring user v of the user u can be calculated according to the following formula:

αᵤᵥ=softmax_{v∈N(u)}(LeakyReLU(Wₐ^{T}[Xᵤ∥Xᵥ]) (1)

Here, Wₐis a to-be-trained parameter, softmax and LeakyReLU are nonlinear activation functions, N(u) is a neighboring user set of the user u, Xᵤand Xᵥ are respectively representations of the user u and the neighboring user v, ∥ is a connection function, and the representation can be represented by using a vector.

When there are m neighboring users v, initial attention of the user u can be represented by using a vector αᵤ=[αᵤ₁∥αᵤ₂∥ . . . ∥αᵤₘ]. For a plurality of users, initial attention vectors of the plurality of users can be concatenated into an initial attention matrix. Therefore, the initial attention can be represented by using a vector, or can be represented by using a matrix.

When the neighboring user node is selected based on the initial attention, because a process is underivable when a uniform distribution is selected, the neighboring user node can be sampled based on the initial attention according to a derivable sampling function, so that a neighbor selection process is derivable. In an implementation, a process of selecting the neighboring user node can be implemented through Gumbel sampling.

For example, sparse Gumbel sampling is performed according to the following formula, to obtain the following one-hot (one-hot) vector, namely, the selective attention vector vᵤ of the user u:

$${v}_{u} = \frac{exp [ \frac{log {α}_{u} + g}{τ} ]}{{Σ}_{v ∈ {N}_{s} ( u )} exp [ \frac{log {α}_{u} + {g}_{v}}{τ} ]} \qquad ( 2 )$$

Here, g follows a Gumbel (0, 1) distribution, Gumbel (0, 1) can be obtained by transforming the uniform distribution, g=−log(−log u), u∈Uniform distribution (0, 1), τ∈(0, +∞) is a hyperparameter and is used to control a sparse one-hot vector, αᵤ is the initial attention vector of the user u, and exp is an exponential function whose base is a natural constant e.

Selective attention vectors of the plurality of user nodes in the relation network can be concatenated into a selective attention matrix for all the users. One neighboring user matrix is actually selected for the user u each time a one-hot vector is obtained according to Formula (2). In a specific implementation, Gumbel sampling can be performed for T times according to Formula (2), to obtain T selected neighboring users of the user u, thereby obtaining a selective attention matrix that are for all the users and that exists when T neighboring users are selected for each user.

$$V = {\sum }_{i = 0}^{T - 1} {V}^{i} / T \qquad ( 3 )$$

Each row in the matrix V can be a selective attention vector of a user for a neighboring user of the user. In the selective attention vector, T elements can have relatively large values (for example, values close to 1), and the other elements have very small values (for example, values close to 0). Different rows in the matrix V represent different users.

Formula (1) to Formula (3) are merely examples of implementations. The formulas are properly deformed based on principles of these formulas, to obtain different calculation formula expression forms. These are all feasible.

After a selective attention vector or a selective attention matrix of a user node to a neighboring user node of the user node is determined, a selective adjacency matrix Aₛ′ including information in the selective attention among a plurality of user nodes can be determined. In a specific implementation, the selective attention matrix can be directly determined as a selective adjacency matrix, or the selective adjacency matrix can be determined based on an original adjacency matrix of the first relation network G₁.

In this implementation, a first original adjacency matrix Aₛ among the plurality of user nodes in the first relation network G₁ can be determined, and the selective adjacency matrix Aₛ′ is determined based on a product of the selective attention matrix V and the first original adjacency matrix Aₛ.

The selective attention matrix V includes selective attention of the plurality of user nodes to respective neighboring user nodes of the plurality of user nodes. The first original adjacency matrix Aₛ can be an adjacency matrix among all the user nodes in the first relation network G₁, and a value of an element is 0 or 1. A value represented by each element indicates whether an association relationship exists between two corresponding user nodes. When the element is 0, it indicates that no association relationship exists between the two user nodes. When the element is 1, it indicates that an association relationship exists. The first original adjacency matrix Aₛ does not include the information in the selective attention, that is, does not include information about a selected neighboring user. The selective adjacency matrix Aₛ′ can be obtained according to the following formula:

$${A}_{s}^{′} = {A}_{s} ⊙ {\sum }_{i = 0}^{T - 1} {V}^{i} / T \qquad ( 4 )$$

Here, Aₛ is the first original adjacency matrix, and ⊙ is a dot product symbol. An element value of an edge that has no association relationship with the user node in the selective attention matrix is set to 0 by using an operation in Formula (4), to improve accuracy of a weight matrix.

The selective adjacency matrix Aₛ′ is a special adjacency matrix, and has the same form as a common adjacency matrix, but has content different from that of the common adjacency matrix. The selective adjacency matrix Aₛ′ includes the information in the selective attention, that is, includes each user node and a selected neighboring user node corresponding to the user node. In the selective adjacency matrix Aₛ′, for a row vector corresponding to a user node, an element value of a selected neighboring user node is completely different from an element value of another user node. For example, the element value of the selected neighboring user node is 1 or close to 1, and the element value of the another user node is 0. In this way, the selected neighboring user node is highlighted.

In step S220, a neighboring node representation in the first relation network G₁ is propagated to a corresponding user node based on the selective adjacency matrix Aₛ′ by using a graph neural network, to obtain a first user aggregation representation H_{U}¹ of the user node. The graph neural network is configured to propagate the neighboring node representation in the first relation network G₁ to the corresponding user node based on the selective adjacency matrix Aₛ′, to obtain the first user aggregation representation H_{U}¹ of the user node. An input to the graph neural network is the selective adjacency matrix Aₛ′ and a node representation, and an output is the first user aggregation representation H_{U}¹ of the user node. When the first relation network includes a plurality of user nodes, a first user aggregation representation H_{U}¹ of each user node can be obtained. In this case, the first user aggregation representation can be represented in a matrix form.

When the neighboring node representation is propagated to the corresponding user node, the neighboring node representation can be propagated to the corresponding user node only based on the neighboring user node representation in the first relation network G₁, or can be propagated to the corresponding user node based on the neighboring user node representation and a neighboring object node representation in the first relation network G₁.

In an implementation, the neighboring user node representation and the neighboring object node representation in the first relation network G₁ can be propagated to the corresponding user node based on the selective adjacency matrix Aₛ′ and an adjacency matrix between the user node and the object node. Specifically, a plurality of implementations can be included. For example, the selective adjacency matrix Aₛ′ and the adjacency matrix between the user node and the object node are constructed into a full adjacency matrix, that is, an adjacency matrix including association relationships among all user nodes and all object nodes. Then, representation propagation is performed based on the full adjacency matrix. In another implementation, representation propagation is performed based on the selective adjacency matrix Aₛ′, to obtain a first aggregation representation of the user node; representation propagation is performed based on the adjacency matrix between the user node and the object node, to obtain a second aggregation representation of the user node; and the first aggregation representation and the second aggregation representation can be combined by using, for example, a multilayer perceptron (Multilayer Perceptron, MLP), to obtain the final first user aggregation representation H_{U}¹.

When the adjacency matrix is obtained, a node representation can be propagated by using the graph neural network in an existing implementation, for example, according to the following formula:

T^{k}=A′ₛ·H^{k} (5)

H^{k+1}σₖ·(T^{k}·W^{k}) (6)

Here, H^{k} is a hidden layer representation of the graph neural network, initial H⁰ is equal to an initial node representation. Aₛ′ is the selective adjacency matrix, W^{k} is a weight matrix of a layer k and is a to-be-trained parameter, and ox is a nonlinear activation function, for example, can be ReLU.

When the node representation is propagated, the node representation can be propagated based on a specified quantity of hops. For example, it is specified that representation propagation is performed in a range of one hop of neighboring node. In addition, representation propagation can alternatively be performed along a specified propagation path. For example, when the user node representation is propagated, the user node representation can be propagated along a propagation path of “user node->user node”.

In step S230, a first predicted association relationship between the user node and the object node is determined based on the first user aggregation representation and an object representation in the first relation network.

In step S240, a first prediction loss is determined based on a difference between the first predicted association relationship and a first existing association relationship. The first existing association relationship is an existing association relationship between the user node and the object node in the first relation network G₁, and can be used as an existing label between a user and an object for use.

The object representation in the first relation network G₁ is an object representation of the object node in the first relation network. The object representation can be an initial object representation, or can be an object representation existing after neighboring nodes are aggregated.

In an implementation, the neighboring node representation can be propagated to the corresponding object node based on an adjacency matrix between the object node in the first relation network G₁ and a neighboring node of the object node, to obtain a first object aggregation representation of the object node, and the first predicted association relationship between the user node and the object node is determined based on the first user aggregation representation and the first object aggregation representation.

When the first object aggregation representation is determined, the first object aggregation representation can be determined based on a specified quantity of hops according to, for example, Formula (5) and Formula (6) by using the graph neural network. For example, it is specified that representation propagation is performed in a range of one hop of neighboring node. In addition, representation propagation can alternatively be performed along a specified propagation path. For example, representation propagation can be performed along a propagation path of “object node->user node”. For a specific implementation process, references can be made to the conventional technology. Details are not described here again.

When the first predicted association relationship is determined, the first predicted association relationship can be obtained based on a product of the first user aggregation representation and the first object aggregation representation. In other words, a similarity between the first user aggregation representation and the first object aggregation representation is sampled to fit an association relationship between the user and the object, for example, fit a tapping behavior of the user for a commodity. When the first prediction loss is determined, the first prediction loss can be determined according to the following formula:

$${L}_{GGAN} = {\sum }_{( u , i ) ∈ O} {‖ {H}_{u} {H}_{i}^{T} - {Y}_{uj} ‖}^{2} \qquad ( 7 )$$

Here, L_{GGAN} is the first prediction loss, Hu is the first user aggregation representation vector of the user u, Hᵢ is a first object aggregation representation vector of a commodity i, HᵤHᵢ^{T} is the first predicted association relationship, Yᵤᵢ is the first existing association relationship, and “∥*∥²” is an L2 norm symbol.

In step S250, at least the attention model is updated based on the first prediction loss. In other words, a to-be-trained parameter in the attention model is updated. In an implementation, the attention model and the graph neural network can be simultaneously updated based on the first prediction loss, so that the model can converge more quickly.

Steps S210 to S250 can be understood as a model iteration process. In a training process, the attention model can be trained for a plurality of times, until a convergence condition is met. For example, a quantity of iteration times reaches a quantity threshold, or the first prediction loss is less than a loss threshold.

After the model training process in the above-mentioned embodiment, the selective adjacency matrix can be obtained by using a well-trained attention model. The selective adjacency matrix includes a reliable neighboring user node of the user node, and the selective adjacency matrix can enable a reliable neighboring user node representation to be propagated to the corresponding user node in propagation of a user node feature, to obtain a more accurate node representation.

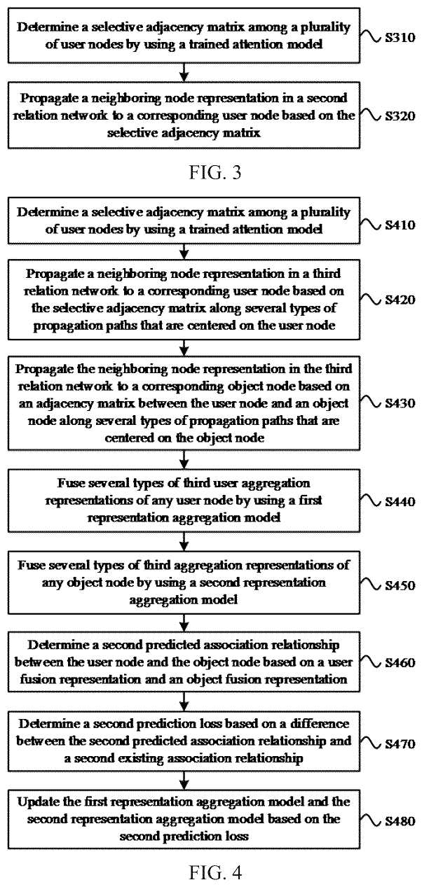

FIG. 3 is a schematic flowchart of a method for determining a node representation in a relation network according to an embodiment. A second relation network G₂ includes a plurality of user nodes, a plurality of object nodes, and an edge that represents an association relationship between different nodes. The second relation network G₂ can be the same as or different from a first relation network G₁. For example, an association relationship between the user node and the object node in the second relation network can be updated relative to the first relation network. The method can be performed by using a computing device, and includes the following steps.

In step S310, a selective adjacency matrix among the plurality of user nodes in the second relation network G₂ is determined by using a trained attention model N1. The attention model is trained in the method described in FIG. 2. Specifically, a user node representation in the second relation network and an association relationship can be input to the attention model N1, and the corresponding selective adjacency matrix is output by using the attention model N1.

When the attention model N1 includes a neural network and a selection unit, initial attention of the user node to a neighboring user node of the user node can be determined based on the user node representation in the second relation network G₂ by using the neural network. The neighboring user node is selected based on the initial attention by using the selection unit, to obtain selective attention of the user node to the neighboring user node of the user node; and a selective adjacency matrix including information in the selective attention among the plurality of user nodes in the second relation network G₂ is determined.

In step S320, the neighboring node representation in the second relation network G₂ is propagated to the corresponding user node based on the selective adjacency matrix, to obtain a second user aggregation representation of the user node. When the neighboring node representation is propagated to the corresponding user node, the neighboring node representation can be propagated to the corresponding user node only based on the neighboring user node representation in the second relation network G₂, or can be propagated to the corresponding user node based on the neighboring user node representation and a neighboring object node representation in the second relation network G₂.

In an implementation, the neighboring user node representation and the neighboring object node representation in the second relation network G₂ can be propagated to the corresponding user node based on the selective adjacency matrix and an adjacency matrix between the user node and the object node. Specifically, a plurality of implementations can be included. For example, the selective adjacency matrix and the adjacency matrix between the user node and the object node are constructed into a full adjacency matrix, that is, an adjacency matrix including association relationships between all user nodes and all object nodes. Then, representation propagation is performed based on the full adjacency matrix. In another implementation, representation propagation is performed based on the selective adjacency matrix, to obtain a third aggregation representation of the user node; representation propagation is performed based on the adjacency matrix between the user node and the object node, to obtain a fourth aggregation representation of the user node; and the third aggregation representation and the fourth aggregation representation can be combined, to obtain the final second user aggregation representation.

The above-mentioned embodiment is a process of generating a user aggregation representation for the second relation network. In a specific implementation, node representation can be propagated based on a specified quantity of hops along a specified propagation path.

To better maintain diversity of node representations, the node representation can alternatively be propagated along a plurality of propagation paths. This specification further provides an embodiment, to learn of a better combination of the plurality of propagation paths through self-supervised multi-representation fusion based on the plurality of propagation paths, thereby improving accuracy and richness of node representations. In this embodiment, multipath representation fusion is separately performed on user node representations and object node representations in a case of a plurality of propagation paths based on the selective adjacency matrix obtained by using the attention model, to obtain a final user fusion representation and a final object fusion representation. Then, whether an association relationship exists between the user and the object is fitted based on a similarity between the user fusion representation and the object fusion representation, and the association relationship is compared with an existing label, to learn of the better combination of the plurality of propagation paths. The following describes this embodiment in detail by using the flowchart in FIG. 4.

FIG. 4 is a schematic flowchart of a method for training a representation aggregation model according to an embodiment. The representation aggregation model is configured to aggregate node representations in a relation network. A third relation network G₃ includes a plurality of user nodes, a plurality of object nodes, and an edge that represents an association relationship between different nodes. The third relation network G₃ can be the same as or different from a first relation network G₁. For example, an association relationship between the user node and the object node in the third relation network G₃ is updated relative to an association relationship between a user node and an object node in the first relation network G₁. The method can be performed by using a computing device, and includes the following steps.

In step S410, a selective adjacency matrix among the plurality of user nodes in the third relation network G₃ is determined by using a trained attention model N1. The attention model is trained in the method described in FIG. 2. Specifically, a user node representation in the third relation network and an association relationship can be input to the attention model N1, and the corresponding selective adjacency matrix is output by using the attention model N1.

When the attention model N1 includes a neural network and a selection unit, initial attention of the user node to a neighboring user node of the user node can be determined based on the user node representation in the third relation network G₃ by using the neural network. The neighboring user node is selected based on the initial attention by using the selection unit, to obtain selective attention of the user node to the neighboring user node of the user node; and a selective adjacency matrix including information in the selective attention among the plurality of user nodes in the third relation network G₃ is determined.

In step S420, neighboring node representations in the third relation network G₃ are aggregated to a corresponding user node based on the selective adjacency matrix along several types of propagation paths that are centered on the user node, to separately obtain several types of third user aggregation representations of the user node.

In step S430, the neighboring node representations in the third relation network G₃ are aggregated to a corresponding object node based on an adjacency matrix between the user node and the object node along several types of propagation paths that are centered on the object node, to separately obtain several types of third object aggregation representations of the object node.

The several types of propagation paths that are centered on the user node can include a user node and an object node. The several types include one or more types. For example, the several types of propagation paths can include a user node, user node->object node, user node->user node, user node->object node->user node, etc. That is, Mᵤ={U, UI, UU, UIU}. Here, U represents a user node, and I represents an object node. In FIG. 1, a path from u₂ to i₁ then to u₄ is a UIU path, and includes two hops of nodes.

The several types of propagation paths that are centered on the object node can include a user node and an object node. For example, the several types of propagation paths can include an object node, object node->user node, object node->user node->object node, object node->user node->user node, etc. That is, M_{I}={I, IU, IUI, IUU}. In FIG. 1, a path from i₁ to u₄ then to i₃ is an IUI path, and a path from i₁ to u₄ then to u₃ is an IUU path.

When the third user aggregation representation is determined, representation aggregation can be separately performed based on a product of the selective adjacency matrix and a node representation matrix along the several types of propagation paths that are centered on the user node. The node representation matrix includes a plurality of user node representations and a plurality of object node representations.

When the third object aggregation representation is determined, representation aggregation can be separately performed based on a product of the adjacency matrix between the user node and the object node and the node representation matrix along the several types of propagation paths that are centered on an object.

For example, representation aggregation can be performed according to the following matrix product transformation formula:

E_{U}=X_{U}; E_{I}=X_{I}; E_{UI}=AₒE_{I}; E_{IU}=Aₒ^{T}E_{U}; (8)

E_{UU}=A′ₛE_{U}; E_{IUU}=AₒE_{UU}=AₒE_{IU}; E_{IUI}=Aₒ^{T}E_{UI} (9)

Here, E_{U}, E_{UI}, E_{UU}, and E_{UIU} are four types of third user aggregation representations respectively corresponding to four types of propagation paths Mᵤ, and E_{I}, E_{IU}, E_{IUI}, and E_{IUU} are four types of third object aggregation representations respectively corresponding to four types of propagation paths M_{I}. X_{U} and X_{I} are respectively an initial user node representation and an initial object node representation, Aₛ′ is the selective adjacency matrix. Aₒ is the adjacency matrix between the user node and the object node, and T is a matrix transposition symbol.

For each user node u in the third relation network G₃, several types of user aggregation representations corresponding to the user node u are obtained. For each object node i in the third relation network G₃, several types of object aggregation representations corresponding to the object node u are obtained.

When a user social relationship in the third relation network G₃ does not change relative to a user social relationship in the first relation network G₁, that is, when an association relationship between user nodes does not change, the selective adjacency matrix can be directly obtained after training of the attention model N1 in FIG. 1 is completed. Further, step S420 can also be performed in advance before a training process in this embodiment starts.

In step S440, several types of third user aggregation representations of any user node are fused by using a first representation aggregation model, to obtain a user fusion representation. The first representation aggregation model can be implemented by using the neural network. The first representation aggregation model is configured to fuse several types of input third user aggregation representations of the user node. An input to the first representation aggregation model is several types of third user aggregation representations corresponding to each of one or more user nodes, and an output is user fusion representations respectively corresponding to the one or more user nodes.

The first representation aggregation model can fuse the several types of third user aggregation representations of the user node based on model parameters in the first representation aggregation model. For example, the several types of third user aggregation representations of the user node can be fused according to the following formula:

$$\begin{matrix}{H}_{p}^{0} = LeakyReLU ( {E}_{p} {W}_{p}^{0} + {b}_{p}^{0} ) ; {\hat{β}}_{p} = LeakyReLU ( {H}_{p}^{0} {W}_{p}^{a} + {b}_{p}^{a} ) & ( 10 ) \\ {β}_{p} = \frac{exp ( {\hat{β}}_{p} )}{{Σ}_{p ∈ {M}_{U}} exp ( {\hat{β}}_{p} )} , {H}_{U}^{m} = {\sum }_{p ∈ {M}_{U}} {β}_{p} \cdot {H}_{p}^{0} & ( 11 )\end{matrix}$$

Here, Wₚ⁰∈R^{d*d}, Wₚ^{a}∈R^{d*1}, bₚ⁰∈R^{d*1}, and bₚ^{a}∈R^{d*1} are model parameters of the first representation aggregation model and are to-be-trained weight matrices, d is a feature dimension, R is a real number set, Hₚ⁰ is a representation of a propagation path p, H_{U}^{m} is a final user fusion representation, U represents all users, and u represents one of all the users.

In step S450, several types of third object aggregation representations of any object node are fused by using a second representation aggregation model, to obtain an object fusion representation. The second representation aggregation model is implemented by using the neural network. The second representation aggregation model is configured to fuse several types of input third object aggregation representations of the object node. An input to the second representation aggregation model is several types of third object aggregation representations corresponding to each of one or more object nodes, and an output is object fusion representations respectively corresponding to the one or more object nodes.

The second representation aggregation model can fuse several types of third object aggregation representations of the object node by using a model parameter in the second representation aggregation model. In a specific implementation, the several types of third object aggregation representations of the object node can be fused according to Formula (10) and Formula (11), the third user aggregation representation in Formula (10) and Formula (11) is replaced with a third object aggregation representation, and the propagation path is replaced with a propagation path centered on an object. A specific formula is not repeatedly listed.

In step S460, a second predicted association relationship between the user node and the object node is determined based on the user fusion representation and the object fusion representation. In step S470, the second prediction loss is determined based on a difference between the second predicted association relationship and a second existing association relationship.

The second predicted association relationship is used to fit an association relationship between a user and an object. The second existing association relationship is an existing association relationship between the user node and the object node in the third relation network G₃, and can be used as an existing label between the user and the object for use.

When the second predicted association relationship is determined, the second predicted association relationship can be obtained based on a product of the user fusion representation and the object fusion representation. In other words, a similarity between the user fusion representation and the object fusion representation is sampled to fit the association relationship between the user and the object, for example, fit a tapping behavior of the user for a commodity. When the second prediction loss is determined, the second prediction loss can be determined according to the following formula:

$${L}_{rec} = {\sum }_{( u , i ) ∈ O} {‖ {H}_{u}^{m} {H}_{i}^{mT} - {F}_{ui} ‖}^{2} \qquad ( 12 )$$

Here, L_{rec} is the second prediction loss, Hᵤ^{m} is a user fusion representation vector of a user u, Hᵢ^{m} is an object fusion representation vector of a commodity i, Hᵤ^{m}Hᵢ^{mT} is the second predicted association relationship, and Fᵤᵢ is the second existing association relationship.

Because of sparse user behaviors, contrastive learning can be introduced as a regularized matrix when a prediction loss is determined, to further optimize a model, so as to enrich a path representation of the user. When being performed, step S470 can include the following steps: step 1 to step 5.

Step 1: Determine, from a neighboring user node of the user node, a neighboring user node selected by using the attention model.

When the neighboring user node selected by using the attention model is determined, the neighboring user node can be determined based on selective attention or a selective attention matrix, or can be determined based on a selective adjacency matrix. The selective attention matrix and the selective adjacency matrix each include a neighboring user node selected by using the attention model for each user node. The neighboring user node can be specifically determined based on a value of an element in the matrix.

Step 2: Determine a first similarity between the user node and the selected neighboring user node, and determine a second similarity between the user node and a user node other than the selected neighboring user node. When the similarity is determined, the similarity is determined based on a product of representation vectors.

For example, a product of a representation of the user node and a representation of the selected neighboring user node is determined as the first similarity; and a product of the representation of the user node and a representation of the user node other than the selected neighboring user node is determined as the second similarity. The representation of the user node can be a user fusion representation, can be any third user aggregation representation, or can be a representation of a propagation path.

Step 3: Determine a first sub-loss based on the first similarity and the second similarity. In a specific implementation, the first sub-loss is determined to maximize the first similarity and minimize the second similarity. For example, the first sub-loss can be constructed according to the following formula:

$${L}_{infoNCE} = {\sum }_{( {u}_{i} , {u}_{j} ∈ {G}_{s} )} - log \frac{exp ( {H}_{p , {u}_{i}}^{0} {H}_{q , {u}_{j}}^{0 T} )}{exp ( {H}_{p , {u}_{i}}^{0} {H}_{q , {u}_{j}}^{0 T} ) + {Σ}_{( {u}_{i} , {u}_{kc} ∉ {G}_{s} )} exp ( {H}_{p , {u}_{i}}^{0} {H}_{q , {u}_{kc}}^{0 T} )} \qquad ( 13 )$$

Here, L_{infoNCE} is the first sub-loss, uᵢ and uⱼ are a pair of neighbors in a selected neighboring user set Gₛ and have a neighboring user relationship, uᵢ and u_{kc} are a pair of users outside the neighboring user set Gₛ and do not have a neighboring user relationship. The neighboring user set Gₛ includes a reliable neighboring selected as a positive sample based on the attention model. Negative samples uᵢ and u_{kc} are introduced here. The user u_{kc} is obtained by randomly selecting L users {u_{kc}, kc=0, 1, . . . , L−1}.

Step 4: Determine a second sub-loss based on a difference between the second predicted association relationship and the second existing association relationship. When this step is performed, references can be made to step S470. For example, the second prediction loss obtained in step S470 can be directly used as the second sub-loss. For example, the prediction loss L_{rec} obtained in Formula (12) is used as the second sub-loss.

Step 5: Determine the second prediction loss based on the first sub-loss and the second sub-loss. When the second prediction loss is determined, a sum of the first sub-loss and the second sub-loss or a weighted sum can be determined as the second prediction loss.

For example, two parts of sub-losses can be constructed into the second prediction loss through weighted summation:

L₂=L_{rec}+γL_{infoNCE} (14)

Here, L₂ is the second prediction loss, L_{infoNCE} is the first sub-loss, L_{rec} is the second sub-loss, and γ is a coefficient for controlling the two parts of losses to be balanced.

Step S480: Update the first representation aggregation model and the second representation aggregation model based on the second prediction loss, that is, update a to-be-trained model parameter in the model.

Steps S410 to S430 can serve as a preparation stage before model training, and steps S440 to S480 are a model training stage. Steps S440 to S480 are one time of model iteration training. In actual application, the first representation aggregation model and the second representation aggregation model can be updated by using the second prediction loss, to execute a model iteration training process for a plurality of times, until the model meets a convergence condition.

The above-mentioned process is a method for jointly training the first representation aggregation model and the second representation aggregation model. In an implementation, only the first representation aggregation model can be trained, and steps S430 and S450 are not performed. In step S460, an object representation is used to replace the object fusion representation. In step S480, only the first representation aggregation model is updated based on the second prediction loss.

In the above-mentioned embodiments, a graph model is decoupled into two parts: One part is a Gumbel sampling (that is, neighboring user selection)-based feature propagation part, and the other part is a self-supervised multi-representation fusion part. The first part can be completed through offline training, and the second part can be online training, to greatly reduce calculation of the online part, and reduce time consumption.

In the first part, the attention model can distinguish social relationships in terms of strength, to select a neighbor that is most useful for a service, and perform denoising processing on the social relationship. In the second part, in this embodiment, representations of a plurality of types of propagation paths are combined, and information about a user with a small quantity of behaviors is supplemented based on neighboring information, to address that low-active user representations is poorly depicted.

According to the method provided in the above-mentioned embodiment, a user representation that aggregates reliable information in the social relationship can be obtained, and a degree of interest of the user in a commodity is fitted based on a similarity between a user representation including rich information and a representation of a to-be-pushed commodity, to push the commodity to the user based on the fitted degree of interest, so that commodity pushing can be more accurate and can be applied to a large-scale online pushing scenario. An application of the user representation is not limited to commodity pushing, and the commodity here can alternatively be another article or product to be allocated to the user. In a specific implementation, after the model is trained, the trained first representation aggregation model and the trained second representation aggregation model can be used to obtain a similarity H_{U}^{m}H_{I}^{m} between the user representation and the representation of the to-be-pushed commodity. References can be made to Formula (10) and Formula (11). Commodity pushing is performed based on the similarity.

In this specification, “first” in words such as the first relation network, the first user aggregation representation, the first predicted association relationship, the first existing association relationship, the first prediction loss, the first original adjacency matrix, and the first object aggregation representation, and words such as “second” or “third” (if any) in this specification are merely used for ease of distinguishing and description, but are not of any limiting significance.

The above-mentioned content describes a specific embodiment of this specification, and another embodiment falls within the scope of the appended claims. In some cases, the actions or steps described in the claims can be performed in a sequence different from that in some embodiments and desired results can still be achieved. In addition, the process depicted in the accompanying drawings does not necessarily need a particular sequence or consecutive sequence to achieve the desired results. In some implementations, multi-tasking and parallel processing are feasible or may be advantageous.

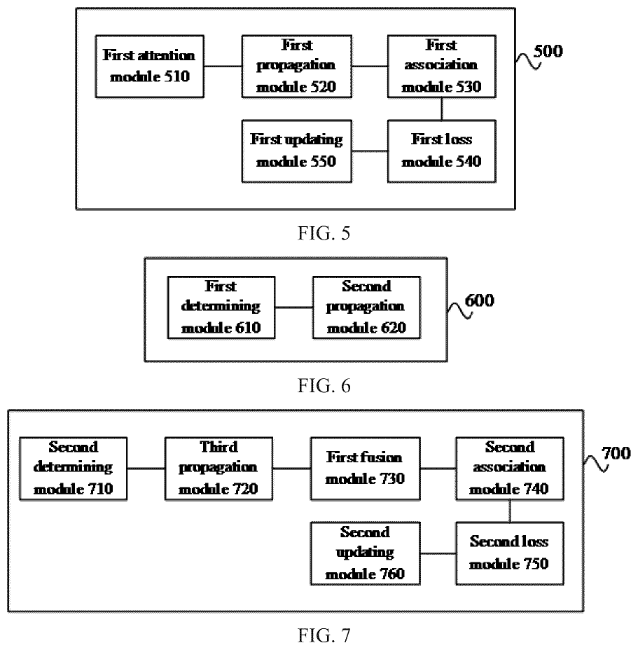

FIG. 5 is a schematic block diagram illustrating an apparatus for training an attention model, according to an embodiment. A first relation network includes a plurality of user nodes, a plurality of object nodes, and an edge that represents an association relationship between different nodes. This apparatus embodiment corresponds to the method embodiment shown in FIG. 2. The apparatus 500 includes:
a first attention module 510, configured to: select a neighboring user node of the user node based on a user node representation in the first relation network by using the attention model, to obtain selective attention of the user node to the neighboring user node of the user node; and determine a selective adjacency matrix including information in the selective attention among the plurality of user nodes;
a first propagation module 520, configured to propagate a neighboring node representation in the first relation network to a corresponding user node based on the selective adjacency matrix by using a graph neural network, to obtain a first user aggregation representation of the user node;
a first association module 530, configured to determine a first predicted association relationship between the user node and the object node based on the first user aggregation representation and an object representation in the first relation network;
a first loss module 540, configured to determine a first prediction loss based on a difference between the first predicted association relationship and a first existing association relationship, where the first existing association relationship is an existing association relationship between the user node and the object node in the first relation network; and
a first updating module 550, configured to update at least the attention model based on the first prediction loss.

In an implementation, the attention model includes a neural network and a selection unit.

The first attention module 510 includes:
a first determining submodule (not shown in the figure), configured to determine initial attention of the user node to the neighboring user node of the user node based on the user node representation in the first relation network by using the neural network; and
a first attention submodule (not shown in the figure), configured to: select the neighboring user node based on the initial attention by using the selection unit, to obtain the selective attention of the user node to the neighboring user node of the user node; and determine the selective adjacency matrix including the information in the selective attention among the plurality of user nodes

In an implementation, when the first attention submodule selects the neighboring user node based on the initial attention by using the selection unit, the following operation is included:
sampling, by using the selection unit, the neighboring user node based on the initial attention according to a derivable sampling function.

In an implementation, when the first attention submodule determines the selective adjacency matrix including the information in the selective attention among the plurality of user nodes, the following operations are included:
determining a first original adjacency matrix among the plurality of user nodes; and
determining the selective adjacency matrix based on a product of a selective attention matrix and the first original adjacency matrix, where the selective attention matrix includes selective attention of the plurality of user nodes to neighboring user nodes of the user nodes.

In an implementation, the first propagation module 520 is specifically configured to:
propagate a neighboring user node representation and a neighboring object node representation in the first relation network to the corresponding user node based on the selective adjacency matrix and an adjacency matrix between the user node and the object node.

In an implementation, the first association module 530 includes:
a first propagation submodule (not shown in the figure), configured to propagate the neighboring node representation to a corresponding object node based on an adjacency matrix between the object node in the first relation network and a neighboring node of the object node, to obtain a first object aggregation representation of the object node; and
a first association submodule (not shown in the figure), configured to determine a first predicted association relationship between the user node and the object node based on the first user aggregation representation and the first object aggregation representation.

In an implementation, the first updating module 550 is specifically configured to:
update the attention model and the graph neural network based on the first prediction loss.

FIG. 6 is a schematic block diagram illustrating an apparatus for determining a node representation in a relation network, according to an embodiment. A second relation network includes a plurality of user nodes, a plurality of object nodes, and an edge that represents an association relationship between different nodes. This apparatus embodiment corresponds to the method embodiment shown in FIG. 3. The apparatus 600 includes:
a first determining module 610, configured to determine a selective adjacency matrix among the plurality of user nodes by using a trained attention model, where the attention model is trained in the method in FIG. 2; and
a second propagation module 620, configured to propagate a neighboring node representation in the second relation network to a corresponding user node based on the selective adjacency matrix, to obtain a second user aggregation representation of the user node.

In an implementation, the second propagation module 620 is specifically configured to:
propagate a neighboring user node representation and a neighboring object node representation in the second relation network to the corresponding user node based on the selective adjacency matrix and an adjacency matrix between the user node and the object node.

FIG. 7 is a schematic block diagram illustrating an apparatus for training a representation aggregation model, according to an embodiment. The representation aggregation model is configured to aggregate representation nodes in a relation network. A third relation network includes a plurality of user nodes, a plurality of object nodes, and an edge that represents an association relationship between different nodes. This apparatus embodiment corresponds to the method embodiment shown in FIG. 4. The apparatus 700 includes:
a second determining module 710, configured to determine a selective adjacency matrix among the plurality of user nodes by using a trained attention model, where the attention model is trained in the method in FIG. 2;
a third propagation module 720, configured to aggregate neighboring node representations in the third relation network to a corresponding user node based on the selective adjacency matrix along several types of propagation paths that are centered on the user node, to separately obtain several types of third user aggregation representations of the user node;
a first fusion module 730, configured to fuse several types of third user aggregation representations of any user node by using a first representation aggregation model, to obtain a user fusion representation;
a second association module 740, configured to determine a second predicted association relationship between the user node and the object node based on the user fusion representation and an object representation in the third relation network;
a second loss module 750, configured to determine a second prediction loss based on a difference between the second predicted association relationship and a second existing association relationship, where the second existing association relationship is an existing association relationship between the user node and the object node in the third relation network; and
a second updating module 760, configured to update the first representation aggregation model based on the second prediction loss.

In an implementation, the second association module 740 includes:
a second propagation submodule (not shown in the figure), configured to aggregate the neighboring node representations in the third relation network to a corresponding object node based on an adjacency matrix between the user node and the object node along several types of propagation paths that are centered on the object node, to separately obtain several types of third object aggregation representations of the object node;
a second fusion submodule (not shown in the figure), configured to fuse several types of third object aggregation representations of any object node by using a second representation aggregation model, to obtain an object fusion representation; and
a second association submodule (not shown in the figure), configured to determine a second predicted association relationship between the user node and the object node based on the user fusion representation and the object fusion representation.

In an implementation, the second updating module 760 is specifically configured to:
update the first representation aggregation model and the second representation aggregation model based on the second prediction loss.

In an implementation, the second loss module 750 includes:
a first determining submodule (not shown in the figure), configured to determine, from a neighboring user node of the user node, a neighboring user node selected by using the attention model;
a second determining submodule (not shown in the figure), configured to: determine a first similarity between the user node and the selected neighboring user node, and determine a second similarity between the user node and a user node other than the selected neighboring user node.
a first loss submodule (not shown in the figure), configured to determine a first sub-loss based on the first similarity and the second similarity;
a second loss submodule (not shown in the figure), configured to determine a second sub-loss based on the difference between the second predicted association relationship and the second existing association relationship; and
a third determining submodule (not shown in the figure), configured to determine the second prediction loss based on the first sub-loss and the second sub-loss.

In an implementation, the several types of propagation paths that are centered on the user node include an object node.

In an implementation, an association relationship between the user node and the object node in the third relation network is updated relative to an association relationship between a user node and an object node in a first relation network.

The apparatus embodiments correspond to the method embodiment. For specific descriptions, references can be made to the descriptions in the method embodiments. Details are not described here again. The apparatus embodiments are obtained based on the corresponding method embodiment, and have the same technical effect as the corresponding method embodiment. For specific descriptions, references can be made to the corresponding method embodiment.

An embodiment of this specification further provides a computer-readable storage medium. The computer-readable storage medium stores a computer program. When the computer program is executed in a computer, the computer is enabled to perform the method described in any one of FIG. 1 to FIG. 4.

An embodiment of this specification further provides a computing device, including a memory and a processor. The memory stores executable code, and when the processor executes the executable code, the method in any one of FIG. 1 to FIG. 4 is implemented.

The embodiments of this specification are described in a progressive way. For same or similar parts in the embodiments, references can be made to each other. Each embodiment focuses on a difference from another embodiment. In particular, the embodiments of the storage medium and the computing device are basically similar to the method embodiment, and therefore are described briefly. For related parts, reference can be made to related descriptions in the method embodiment.

A person skilled in the art should be aware that in the one or more examples, functions described in embodiments of the present invention can be implemented by hardware, software, firmware, or any combination thereof. When the functions are implemented by using software, the functions can be stored in a computer-readable medium or transmitted as one or more instructions or code in the computer-readable medium.

The above-mentioned specific implementations further describe the objectives, technical solutions, and beneficial effects of the embodiments of the present invention in detail. It should be understood that the above-mentioned descriptions are merely specific implementations of embodiments of the present invention, but are not intended to limit the protection scope of the present invention. Any modification, equivalent replacement, or improvement made based on the technical solutions of the present invention shall fall within the protection scope of the present invention.

What is claimed is:

1. A method for training an attention model based on a neighboring user in a relation network, wherein a first relation network comprises a plurality of user nodes, a plurality of object nodes, and an edge that represents an association relationship between different nodes, and the method comprises:
selecting a neighboring user node of the user node based on a user node representation in the first relation network by using the attention model, to obtain selective attention of the user node to the neighboring user node of the user node; and determining a selective adjacency matrix comprising information in the selective attention among the plurality of user nodes;
propagating a neighboring node representation in the first relation network to a corresponding user node based on the selective adjacency matrix by using a graph neural network, to obtain a first user aggregation representation of the user node;
determining a first predicted association relationship between the user node and the object node based on the first user aggregation representation and an object representation in the first relation network;
determining a first prediction loss based on a difference between the first predicted association relationship and a first existing association relationship, wherein the first existing association relationship is an existing association relationship between the user node and the object node in the first relation network; and
updating at least the attention model based on the first prediction loss.

2. The method according to claim 1, wherein the attention model comprises a neural network and a selection unit; and
the step of selecting a neighboring user node of the user node and the step of determining a selective adjacency matrix comprising information in the selective attention among the plurality of user nodes comprise:
determining initial attention of the user node to the neighboring user node of the user node based on the user node representation in the first relation network by using the neural network; and
selecting the neighboring user node based on the initial attention by using the selection unit, to obtain the selective attention of the user node to the neighboring user node of the user node; and determining the selective adjacency matrix comprising the information in the selective attention among the plurality of user nodes.

3. The method according to claim 2, wherein the step of selecting the neighboring user node based on the initial attention comprises:
sampling the neighboring user node based on the initial attention according to a derivable sampling function.

4. The method according to claim 2, wherein the step of determining the selective adjacency matrix comprising the information in the selective attention among the plurality of user nodes comprises:
determining a first original adjacency matrix among the plurality of user nodes; and
determining the selective adjacency matrix based on a product of a selective attention matrix and the first original adjacency matrix, wherein the selective attention matrix comprises selective attention of the plurality of user nodes to neighboring user nodes of the user nodes.

5. The method according to claim 1, wherein the step of propagating a neighboring node representation in the first relation network to a corresponding user node comprises:
propagating a neighboring user node representation and a neighboring object node representation in the first relation network to the corresponding user node based on the selective adjacency matrix and an adjacency matrix between the user node and the object node.

6. The method according to claim 1, wherein the step of determining a first predicted association relationship between the user node and the object node comprises:
propagating the neighboring node representation to a corresponding object node based on an adjacency matrix between the object node in the first relation network and a neighboring node of the object node, to obtain a first object aggregation representation of the object node; and
determining a first predicted association relationship between the user node and the object node based on the first user aggregation representation and the first object aggregation representation.

7. The method according to claim 1, wherein the step of updating at least the attention model based on the first prediction loss comprises:
updating the attention model and the graph neural network based on the first prediction loss.

8. A non-transitory computer-readable storage medium comprising instructions stored therein that, when executed by a processor of a computing device, cause the processor to:
select a neighboring user node of the user node based on a user node representation in the first relation network by using the attention model, to obtain selective attention of the user node to the neighboring user node of the user node; and determine a selective adjacency matrix comprising information in the selective attention among the plurality of user nodes;
propagate a neighboring node representation in the first relation network to a corresponding user node based on the selective adjacency matrix by using a graph neural network, to obtain a first user aggregation representation of the user node;
determine a first predicted association relationship between the user node and the object node based on the first user aggregation representation and an object representation in the first relation network;
determine a first prediction loss based on a difference between the first predicted association relationship and a first existing association relationship, wherein the first existing association relationship is an existing association relationship between the user node and the object node in the first relation network; and
updating at least the attention model based on the first prediction loss.

9. A computing device, comprising a memory and a processor, wherein the memory stores executable instructions that, in response to execution by the processor, cause the processor to:
select a neighboring user node of the user node based on a user node representation in the first relation network by using the attention model, to obtain selective attention of the user node to the neighboring user node of the user node; and determine a selective adjacency matrix comprising information in the selective attention among the plurality of user nodes;
propagating a neighboring node representation in the first relation network to a corresponding user node based on the selective adjacency matrix by using a graph neural network, to obtain a first user aggregation representation of the user node;
determining a first predicted association relationship between the user node and the object node based on the first user aggregation representation and an object representation in the first relation network;
determining a first prediction loss based on a difference between the first predicted association relationship and a first existing association relationship, wherein the first existing association relationship is an existing association relationship between the user node and the object node in the first relation network; and
updating at least the attention model based on the first prediction loss.
